(19) United States
(12) Patent Application Publication
(10) Pub. No.: US 2015/0315819 A1
(43) Pub. Date: Nov. 5, 2015

(54) Electromagnetic Latching Mechanism

(71) Applicant: Open Mind Innovations, Inc, Las Vegas, NV (US)

(72) Inventors: John Gerhardt, Las Vegas, NV (US); Robert Griffiths, Las Vegas, NV (US)

(21) Appl. No.: 14/702,600

(22) Filed: May 1, 2015

Related U.S. Application Data
(60) Provisional application No. 61/988,059, filed on May 2, 2014.

(51) Int. Cl. E05B 47/02; E05C 3/12

(52) U.S. Cl. CPC E05B 47/023; E05C 3/12

(57) ABSTRACT

A latching mechanism selectively joins two surfaces and/or objects and includes a latch and a catch. The latch includes a pivoting locking member with respect to the latch that pivots between a locked position and an unlocked position. An electromagnetic coil housed within the latch is selectively energized to cause pivotal movement of the locking member. The catch defines at least one pocket for receiving a portion of the locking member when the locking member is in the locked position and the latch and the catch are engaged. The latching mechanism may be normally-locked, such that the energizing of the coil moves the locking member to the unlocked position, or normally-unlocked, with the energizing of the coil moving the locking member to the locked position.

### CROSS REFERENCE TO RELATED APPLICATION

This application claims the benefit of and priority to U.S. Provisional Application No. 61/988,059 which was filed May 2, 2014, the contents of which are hereby incorporated by reference.

### BACKGROUND

1. Field

The disclosed embodiments relate generally to latching mechanisms for doors or windows and more specifically to latches having a locking member that may be selectively energized by an electromagnetic coil to move between a locked and an unlocked position.

2. Related Art

Generally speaking, latching mechanisms selectively join two or more surfaces together while still allowing for their eventual and/or regular separation. In some latching mechanisms, a latch mounted on one of the surfaces selectively engages a catch mounted on the other surface. For example, a latch placed on an interior surface of a cabinet may engage a catch mounted on a cabinet door, thereby selectively joining the cabinet and the door to maintain the cabinet door in a closed position.

Typical latching devices are generally not designed to withstand any sort of large external force. For example, during an earthquake, the motion of a cabinet may disengage the latch from the catch, causing the cabinet door to open and the contents of the cabinet to spill out, which can result in personal injury and property damage. When the cabinet is located on a motor vehicle or an aircraft, the forces exerted on the cabinet during normal operation of the vehicle or aircraft may also tend to disengage the latching mechanism. A latching mechanism designed to withstand these external forces would be especially useful in such situations. Other latches may be complex requiring a large number of parts. Such latches may be easily damaged and expensive due to the complexity.

Access to cabinets and other doors in places such as hospitals or prisons must be tightly controlled. To facilitate this control, it may be useful to keep cabinets and doors in such locations in a normally locked state, with access being granted only when certain conditions are met. A latching mechanism allowing separation of the latch and the catch in response to a predetermined condition would provide such controlled access. Such a latching mechanism should also be low cost so that is can economically be implemented in such facilities.

### SUMMARY

The disclosed embodiments have been developed in light of the above, and aspects of the invention may include latching mechanism and systems of latching mechanisms. In one embodiment, a latching mechanism for selectively joining two surfaces and/or objects comprises a latch that has a locking member with a magnetic end and a locking end. The locking member pivots with respect to the latch between a locked position and an unlocked position. There is also an electromagnetic coil disposed in a working relationship to the magnetic end of the locking member, such that energizing the coil causes pivotal movement of the locking member. The latching mechanism may further have a power source for selectively energizing the coil; and a catch defining at least one pocket for receiving the locking end of the locking member when the locking member is in the locked position.

In some embodiments, the locking member is selectively predisposed to be normally-locked or normally-unlocked. Energizing the coil thus pivots the locking member to the unlocked position when it is normally-locked, and pivots the locking member to the locked position when it is normally-unlocked.

The electromagnetic coil may include a magnetic core having a residual magnetism when the electromagnetic coil is de-energized. The residual magnetism maintains the locking member in one of the normally-locked and normally-unlocked positions.

In one embodiment, the locking member comprises a magnet. The locking member may be switched from being predisposed as normally-locked to normally-unlocked and from normally-unlocked to normally-locked by rotating the locking member about a longitudinal axis of the locking member by 180 degrees.

In some embodiments, the catch may comprise a keeper that extends from a base of the catch and at least one projection that at least partially defines the at least one pocket. The at least one projection extends from the keeper at an angle of approximately 70 degrees. The locking end of the locking member may have a lock formed in a t-shape and ends of the lock that are rounded.

The latching mechanism may further comprise an electronic control unit configured to control the energizing of the coil. The electronic control unit may include a transceiver to receive an instruction to energize the coil to lock or unlock the latching mechanism. The electronic control unit may also comprise at least one sensor. The electronic control unit may control the energizing of the coil in response to an output from the at least one sensor. For example, the sensor may be an accelerometer, and the electronic control unit may be configured to energize the coil to lock the latching mechanism in response to an output of the accelerometer exceeding a predetermined threshold.

In other embodiments, there is a system of latching mechanisms for selectively locking at least one first object to at least one second object. The system may include at least one latching mechanism having a latch with a locking member. The locking member may have a magnetic end and a locking end, and pivots with respect to the latch between a locked position and an unlocked position. The latching mechanism may also have an electromagnetic coil disposed in a working relationship to the magnetic end of the locking member, such that energizing the coil causes pivotal movement of the locking member. There may also be a power source for selectively energizing the coil, and a catch defining at least one pocket for receiving the locking end of the locking member when the locking member is in the locked position.

The system further includes a controller communicatively coupled to the at least one latching mechanism, the controller being configured to selectively lock and unlock that at least one latching mechanism. For example, the system may further include a remote device, the remote device being communicatively coupled to the controller. The remote device has an input to receive an instruction to selectively lock and unlock the at least one latching mechanism. The system remote device comprises at least one of a fob, a desktop computer, a phone, and a personal computing device. The user device may be communicatively linked to the controller via a network.

The system's controller may also include a memory that has program instructions to unlock the latching mechanism based on input identifying an authorized user. For example, the controller may be configured to authorize a user based on at least one of an authorized user device, RFID tag, and biometric information.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a perspective view of a latching mechanism according to an exemplary embodiment.

FIG. 2 is an exploded view of the latching mechanism of FIG. 1.

FIG. 3 is a perspective view of a top plate and a locking member of the latching mechanism of FIG. 1.

FIG. 4 is a perspective view of the top plate and a base plate of the latching mechanism of FIG. 1.

FIG. 5 is a perspective view showing the underside of a catch according to the latching mechanism of FIG. 1.

FIG. 6 is block diagram of a latching mechanism controller according to an exemplary embodiment.

FIG. 7 is a block diagram of a system including a plurality of latching mechanisms according to an exemplary embodiment.

### DETAILED DESCRIPTION OF EMBODIMENTS

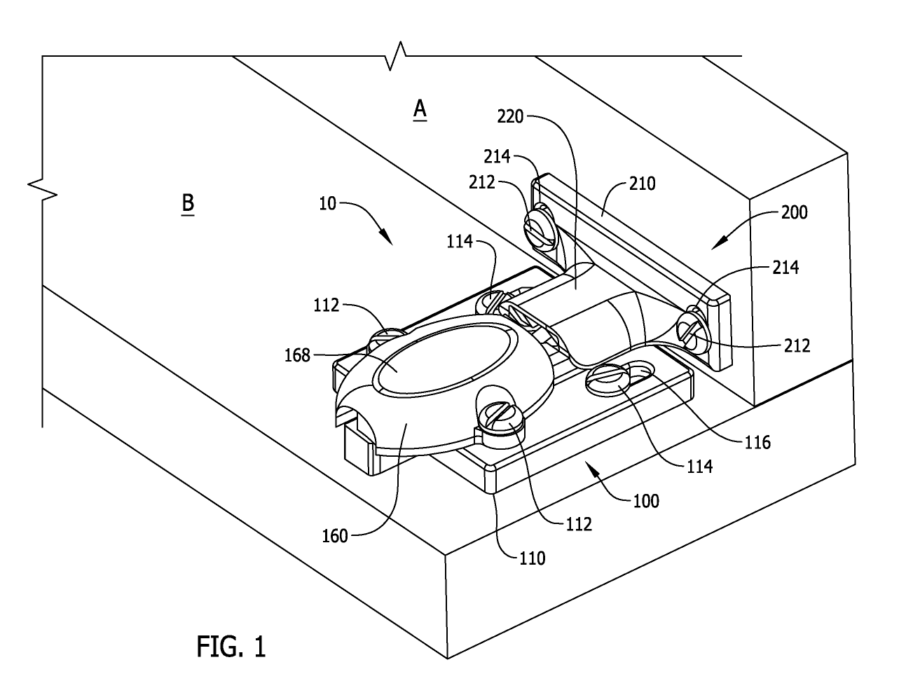

FIG. 1 depicts a latching mechanism generally at 10 configured to selectively join a first surface A and a second surface B. In one embodiment, surface A is a surface of a cabinet door and surface B is a surface of a stationary cabinet wall. Use of the latching mechanism 10 on a cabinet is illustrative as the latching mechanism 10 may be used to selectively join any two suitable surfaces and/or objects. The latching mechanism 10 includes a latch 100 mounted on the interior surface of the cabinet B and a catch 200 mounted on the cabinet door A. The latch 100 and the catch 200 may be formed of any material sufficient to withstand the expected wear and tear of use such as plastics, metal, composites, or any other material. The latch 100 and the catch 200 are positioned such that the latch 100 can engage the catch 200 when the cabinet door A is in a closed position, as shown in FIG. 1, to selectively lock the cabinet door A to the cabinet B.

The latch 100 and the catch 200 may mount to their respective surfaces A, B via pins 112, 114, 212, as shown. The pins 112, 114, 212 may be screws, bolts, nails or any other type of connector suitable for anchoring the latching mechanism 10 to the surfaces A, B. Alternatively, the latch 100 and the catch 200 may be attached using adhesives or any other type of attachment mechanism, or may be integrally formed with the surfaces A, B.

One or more pin-receiving openings 116, 118, 214 may be disposed on the latch 100 and the catch 200. The openings 116, 118, 214 may be circular or may be elongated in one or more directions to facilitate adjustment of either the latch 100 or the catch 200. For example, adjustment of the position of the latch 100 could occur by removing pins 112, loosening pins 114 and sliding the latch 100 as allowed by the interaction of pins 114 with opening 116. This allows the latch 100 to be moved to a different position along the surface of the cabinet B. Once the proper alignment is made, pins 112 may then be installed to secure the new position of the latch 14.

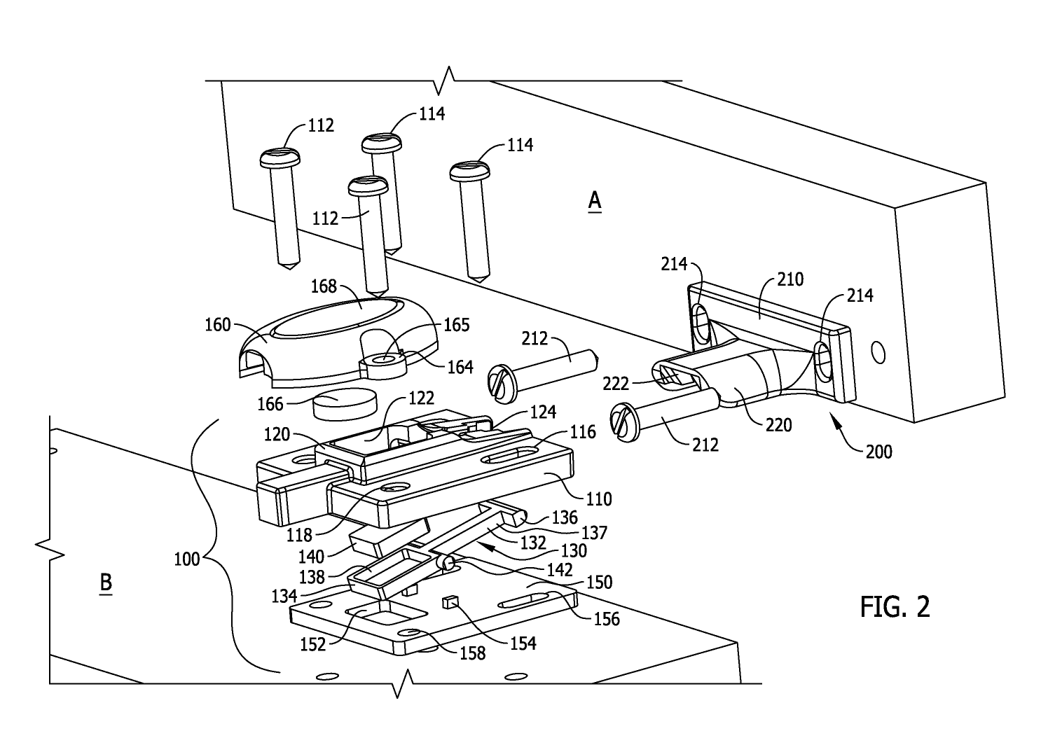

FIG. 2 presents an exploded view of the latching mechanism 10 of FIG. 1. As shown in FIG. 2, the latch 100 includes a base plate 150, a locking member 130, a top plate 110 and a cap 160. The locking member 130 includes a locking end 132 and a magnetic end 134. The locking end 132 is generally T-shaped, with a lock 136 extending from an arm 137. The magnetic end 134 can be configured to receive a magnet 140, can be constructed from a magnetic material, or can be magnetized in any other manner. In this embodiment, the magnetic end includes a cutout portion 138 configured to receive a magnet 140 therein.

The locking member 140 further includes pivots 142 disposed near the junction of the locking end 132 and the magnetic end 134. The pivots 142 serve to hold the locking member 130 in position with respect to the latch 100. The pivots 142 may rest atop fulcrums or stands 154 disposed on the base plate 150 for further stabilization of the latching mechanism 10. The pivots 142 may be cylindrical members extending outward from the locking member 130, may be formed integrally with the locking member or attached thereto, or may be otherwise provided. The base plate 150 and the top plate 110 may snap together or connect in some other manner.

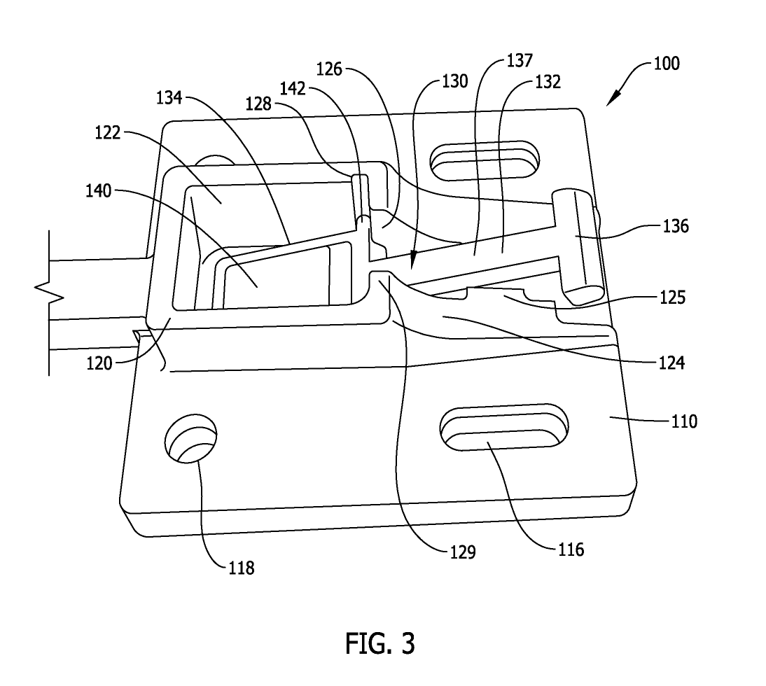

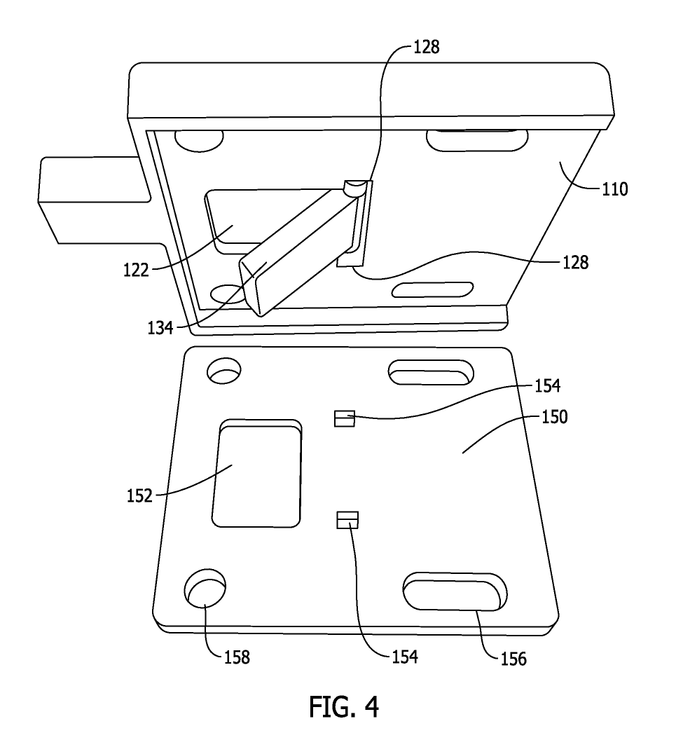

Turning to FIG. 3, the locking member 130 and the top plate 110 are shown generally from above. The top plate 110 includes ridges 120 defining an opening 122 through which the locking member 130 extends, such that the magnetic end 134 is substantially surrounded by the ridges 120 but free to move within the opening 122, while the locking end 132 seats within a channel 126 defined by ramps 124 extending downward and away from the ridges 120. The pivots 142 may seat within grooves 120 formed in the top plate 110 to position the locking member 130 within the latch 100. The grooves 128 may be formed in the ridges 120 as shown in FIGS. 3 and 4. Lateral movement of the arm 137 is restrained by the ramps 124, while a neck 129 formed by the ridges 120 restricts longitudinal movement of the locking member 130 with respect to the top plate 110.

The locking member 130 is pivotable between an unlocked position and a locked position. The locking member 130 pivots at pivots 142 within the grooves 128 and/or about the stands 154 disposed on the base plate 150, or about any other portion of the latch 100. When the locking member 130 is in the locked position, the lock 136 is pivoted upward such that it may engage with the catch 200 when the door A is in close proximity to the cabinet B, thereby locking the door A to the cabinet B. As the locking end 132 pivots upward, the magnetic end 134 pivots downward. As seen in FIG. 4, a clearance opening 152 is formed in or through the base plate 150 may prevent the base plate 150 from impeding movement of the magnetic end 134 as the locking member 130 moves to and/or remains in the locked position.

Movement of the locking member 130 between the locked and unlocked positions is controlled by an electromagnetic coil 166. Turning back to FIG. 2, the coil 166 seats within the cap 160, and may be selectively energized by a power source (described below) to cause movement of the magnetic end 134 of the locking member 130. The coil 166 may be disposed directly above the magnet 140 as depicted, thus maximizing the impact of the magnetic force generated by the energized coil 166 on the magnetic end 134 of the locking member 130. However, it matters only that the coil 166 be positioned such that the energizing thereof will cause movement of the locking member 130. The ramps 124 descending from the ridges 120 assist in the mating of the latch 100 and the catch 200 as the cabinet door A is closed.

As explained above, the pins 112, 114 attach the latch 100 to the surface B. The pins 112, 114 also simultaneously attach the cap 160, top plate 110, locking member 130, and base place 150. In this embodiment, the cap 160 includes flanges 164 with apertures 165. The apertures 165 align with apertures 118 of the top plate 110. Similarly, the base plate 110 further comprises apertures 156, 158 that correspond with apertures 112, 114. In this manner, pins 112 are received in apertures 164, 118, and 158, and pins 114 are received in apertures 116 and 156, thereby attached the portions of the latch 100 together while attaching the latch to the surface B.

The cap 160 further comprises a housing 168. The housing 168 houses a controller 170 including a power source for the latching mechanism 10 as described in more detail below.

In one embodiment, the locking member 130 is configured to be predisposed in the unlocked position, or to be normally-unlocking. In this embodiment, the energizing of the coil 166 repels the magnet 140, thereby exerting a downward force on the magnetic end 134 of the locking member 130. This force pushes the magnetic end 134 downward, thus pivoting the locking end 132 upward until the locking member 130 is in the locked position. When the coil 166 is de-energized, the residual magnetism of the core of the electromagnetic coil 166 attracts the magnetic end 134, pulling the locking member 130 out of the locked position and back to the unlocked position.

In another embodiment, the locking member 130 is configured to be predisposed in the locked position, or to be normally-locking with the magnetic end 134 down and the locking end 132 up. In this embodiment, the energizing of the coil 166 attracts the magnet 140, thus pulling the magnetic end 134 of the locking member 130 upward and pivoting the locking end 132 down out of the locked position and thus out of engagement with the catch 200. When the coil 166 is de-energized, the residual magnetism of the core of the coil 166 repels the magnetic end 134, pushing the locking member 130 back into the locked position.

In yet a further embodiment, the latching mechanism 10 may be switched from normally-locking to normally-unlocking by rotating the locking member 130 about its longitudinal axis by 180 degrees, thereby reversing the polarity of the magnetic end 134.

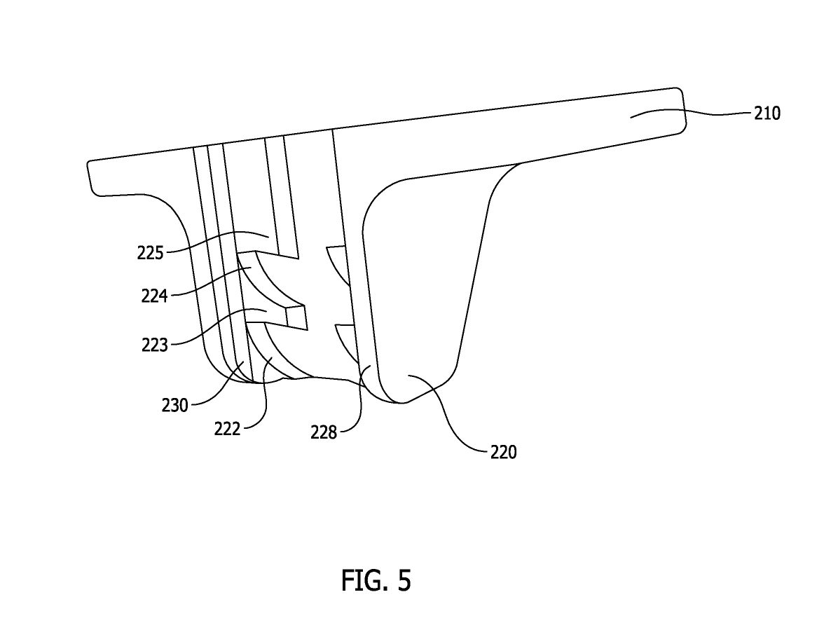

Turning now to FIG. 5, the catch 200 is shown in more detail. The catch 200 includes a keeper 220 projecting out from a base 210. Pins 212 attach the base 210 to the cabinet door A at openings 214. The keeper 220 includes guide rails 228, and ramps 230 which generally correspond in shape to the ramps 124 on the top plate 110, thereby helping to align the latch 100 and the catch 200 when they are engaged.

The catch 200 further comprises a first set of projections 222 extending downward and inward with respect to the keeper 220. The first projections 222 at least partially define a first pocket 223. A second set of projections 225 also extend downward and inward with respect to the keeper 220 and at least partially define a second pocket 225. The projections 222, 224 are sufficiently angled to retain the lock 136 within the respective pockets 223, 225 when the locking member 130 is in the locked position and the cabinet door A is closed, thereby locking the cabinet door A to the cabinet B. The pockets 223, 225 may thus be shaped to correspond to the shape of the lock 136. The projections 222, 224 also act as a stop, retaining the lock 136 within the corresponding pocket 223, 225 when a user attempts to open a locked door A. The angle of the projections 222, 224 may be approximately 70 degrees.

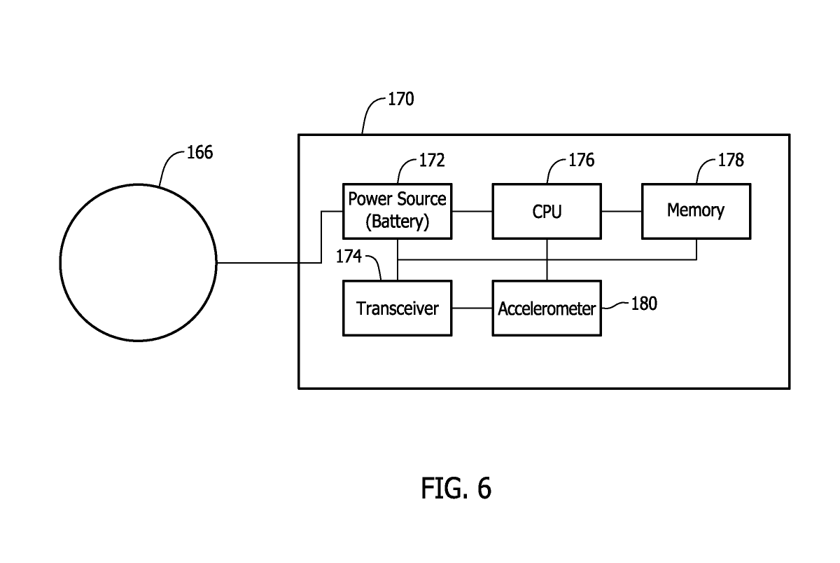

FIG. 6 is block diagram of a latching mechanism controller according to an exemplary embodiment. As stated above, the latching mechanism 10 has a controller that is stored in the housing 168. The controller may be an electronic control unit 170 (ECU). The ECU 170 is connected to the coil 166 and controls the operation of the coil 166 to lock and unlock the latching mechanism 110.

In one embodiment, the ECU 170 includes a power source 172 such as a battery. The battery may be any suitable type of battery such as an alkaline, lithium-ion, or the like. The power source 172 may alternately be an electrical link to an external power supply, such as AC power or an external battery. In another embodiment, the ECU 170 has an AC power source and a battery power source as a backup to the AC power source.

The ECU 170 may further include a CPU 176 that executes control instructions based on data stored in a memory 178. The memory may comprise RAM and ROM. The ECU 170 may also include one or more sensors such as an accelerometer 180 which measures an acceleration in one or more direction. The ECU may be communicatively coupled to external devices via at least one transceiver 174. The transceiver 174 may facilitate wired or wireless transmission of data via any number of protocols including wifi, Bluetooth, NFC, and the like.

In this embodiment, the ECU 170 may energize the coil 166 based on a command from the CPU 176. For example, the ECU 170 may energize the coil 166 in response to a signal received from the accelerometer 180 based on the program instructions stored in the memory 178. Here, when the accelerometer detects a force greater than a predetermined threshold, the CPU may send a signal to the coil to energize (or de-energize). In another embodiment, the CPU 176 may control the coil 166 to energize based on an external command received through the transceiver 174. The CPU 176 may control the coil 166 based on any number of conditions or timers as stored in the program instructions on the memory 178.

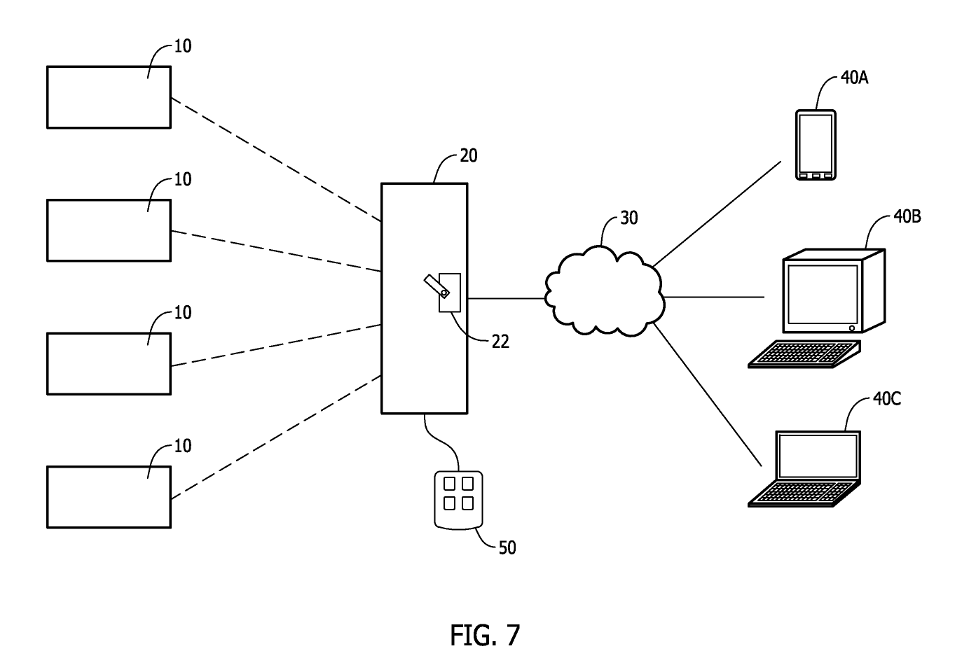

FIG. 7 is a block diagram of system including a plurality of latching mechanisms according to an exemplary embodiment. Here, a number of latching mechanisms 10 may be simultaneously controlled. The latching mechanisms 10 may be installed on a plurality of cabinets in a single room, or may be installed in separate locations. The latching mechanisms 10 may be communicatively coupled to a central latching controller 20. The latching mechanisms 10 may be connected to the latching controller 20 wired or wirelessly via the transceiver 174.

The latching controller 20 may control the latching mechanisms 10 to lock or unlock all of the latching mechanisms 10 or one or more of the latching mechanisms 10. For example, the latching controller may include at least one switch 22 or other controls such as buttons, touch screens, a keyboard, mouse, etc. to allow a user to selectively lock or unlock at least one of the latching mechanisms 10.

The latching controller 20 may be wired or wirelessly connected to a fob 50 to remotely control the latching mechanisms 10. Of course, the fob 50 may also communicate directly with one or more latching mechanisms 10 via the transceiver 174.

The latching controller 20 may be wired or wirelessly connected to a network 30, such as a local area network or the Internet. This may further aid in the remote control of the latching mechanisms. For example, a user device 40, such as a phone, tablet, or other pda 40A; a desktop computer 40B; and/or a laptop computer 40C may be connected to the network 30. The user device 40 may comprise program instructions to communicate via the network 30 with the latching mechanisms 10. In this manner, if the user device 40 is connected to the network 30, a user may control the latching mechanisms 10 with the user device 40. The program instructions on the user device 40 may further allow the user to view other information about the latching mechanisms 10, such as whether the latching mechanism 10 is in a locked or unlocked position and the state of charge of the battery 172 of the latching mechanism 10.

The latching mechanisms 10 may thus have application for a variety of situations. For example, the latching mechanisms 10 can provide earthquake protection to ensure that items in cabinets do not fall out. This may save a user from substantial property damage or personal injury in the event of an earthquake.

In this scenario, the projections 222, 224 serve as a safety mechanism when the contents of a cabinet shift during the earthquake. When the latching mechanism 10 is used as an earthquake lock, the locking member 130 may be predisposed in the unlocked position. During an earthquake, the controller 170 detects movement via the accelerometer 180 and energizes the coil 166. This repels the magnetic end 134 of the locking member 130 and pivots the lock 136 up into the first or second pocket 223, 225.

The ECU 170 may be programmed to keep the locking member 130 in the locked position for a predetermined period of time, or until a user provides an input via the latching controller 20 to unlock the latching mechanism 10. According, once the threat is over, or once a user wishes to re-open the cabinet, the ECU 170 signals to de-energize the coil 166. When this occurs, the locking member 130 pivots out of the locked position due to the attractive forces of the core of the coil 166. That is, the residual magnetism of the core of the electromagnetic coil 166 attracts the magnetic end 134 of the locking member 130, thereby swinging the lock 136 out of the pocket 223, 225.

It is noted that the unlocking of a cabinet after an earthquake may be dangerous if the contents of the cabinet shifted during the earthquake. The projections 222, 224 prevent injury in such a situation by preventing movement of the lock 136 out of the respective pocket 223,225 when the force of the items pressing on the door A is greater than the magnetic force from the core attempting to pull the lock 136 out of the pocket 223, 225. This is due to the angle of the projections 222, 224 with respect to the keeper 220. To open a cabinet in this situation, the user may push lightly on the cabinet door A enough to allow the lock 136 to release from the pocket 223, 225 and unlock the door A. Then the user may carefully open the door B, aware of the items potentially about to spill from the cabinet.

In similar applications, the latching mechanisms 10 may be used in boat, RV, yacht, or airplane storage bin where contents within the storage bin may likely shift and fall out of the storage bin. Using the latching mechanisms 10, the storage bins may automatically lock when the accelerometer detects sufficient turbulence to cause items to potentially move within the storage bin.

As another advantage of the present configuration, the latching mechanism 10 allows the door A to close even when the locking member 130 is already in the locked position. Referring to FIG. 3, it can be seen that the lock 136 is angled and partially rounded. This configuration of the lock 136 allows the lock 136 to slide along the projection 222 to eventually settle into the first pocket 223 when one attempts to close the cabinet door A while the locking member 136 is in the locked position. As the cabinet door A continues to close, the lock 136 slides along the additional projection 224, coming to rest in the second pocket 225. Thus the latching mechanism 10 of the present invention allows the cabinet door A to be closed whether the locking member 130 is in the unlocked or locked position.

With two pockets 223, 225, the door A can lock whether the lock 136 rests in either pocket 223 or 225. In this manner, the door A can lock without being fully closed. The lock 136 may be angled and partially rounded both on the top and the bottom, such that longitudinally rotating the locking member 136 to switch the predisposition of the latching mechanism 10 from normally-locking to normally-unlocking (or the reverse) does not affect this capability.

In another embodiment, the latching mechanisms 10 may provide enhanced security for items stored within a cabinet, closet, bin, or the like. The controller 20 or the ECU 170 may be configured such that only authorized access to the contents is allowed.

For example, the controller 20 or ECU 170 may store in memory a list of authorized personnel for a certain cabinet or bank of cabinets, energizing the coil 166 to unlock normally-locked cabinets only when persons from the list are in close proximity. Proximity may be detected by a badge, RFID tag, NFC, Bluetooth, or other device being worn or operated by the authorized person. In one embodiment, the authorized person may operate a fob 50 or an application on a smart phone 40A to unlock one or more of the latching mechanisms 10. In another embodiment, the ECU 170 or controller 20 detects an RFID tag on a badge worn by the authorized person. In another alternative, the controller 20 or user device 40 may include a device that detects biometrics such as a fingerprint scan or facial recognition.

In addition to controlling access to authorized persons, the controller 20 or ECU 170 may also include a memory device to store information such as which cabinet was accessed by whom and for how long, and/or when the cabinet is manually forced open, such as during an attempted theft.

It should be appreciated that the latching mechanism 10 according to the above-described embodiments can provide for controlled-access storage for medications, jewels, hazardous chemicals, gun storage, etc. In this situation, the latching mechanism 10 would be normally-locked, with the locking member 130 pivoting out of the locked position in response to the energizing of the coil 166. The locking member 130 returns to the locked position when the coil is de-energized, thus re-locking the door B. The latching mechanism 10 may be re-locked after a predetermined time, or in response to another signal from the user. Both AC power and battery power may be employed to ensure the energizing of the coil 166 at appropriate times even during a power failure.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A latching mechanism for selectively joining two surfaces and/or objects comprising:
a latch comprising a locking member having a magnetic end and a locking end, wherein the locking member pivots with respect to the latch between a locked position and an unlocked position;
an electromagnetic coil disposed in a working relationship to the magnetic end of the locking member, such that energizing the coil causes pivotal movement of the locking member;
a power source for selectively energizing the coil; and
a catch defining at least one pocket for receiving the locking end of the locking member when the locking member is in the locked position.

2. The latching mechanism of claim 1, wherein the locking member is selectively predisposed to be normally-locked or normally-unlocked, the energizing of the coil pivoting the locking member to the unlocked position when normally-locked, and the energizing of the coil pivoting the locking member to the locked position when normally-unlocked.

3. The latching mechanism of claim 2, wherein the electromagnetic coil includes a magnetic core having a residual magnetism when the electromagnetic coil is de-energized, the residual magnetism maintaining the locking member in one of the normally-locked and normally-unlocked positions.

4. The latching mechanism of claim 2, wherein the locking member comprises a magnet, and the locking member is switched from normally-locked to normally-unlocked and from normally-unlocked to normally-locked by rotating the locking member about a longitudinal axis of the locking member by 180 degrees.

5. The latching mechanism of claim 1, wherein the catch comprises a keeper that extends from a base and at least one projection that at least partially defines the at least one pocket.

6. The latching mechanism of claim 5, wherein the at least one projection extends from the keeper at an angle of 70 degrees.

7. The latching mechanism of claim 1, wherein the locking end of the locking member has a lock formed in a t-shape and ends of the lock are rounded.

8. The latching mechanism of claim 1, further comprising an electronic control unit configured to control the energizing of the coil, the electronic control unit comprising a transceiver to receive an instruction to energize the coil to lock or unlock the latching mechanism.

9. The latching mechanism of claim 8, wherein the electronic control unit comprises at least one sensor, and the electronic control unit is configured to control the energizing of the coil in response to an output from the at least one sensor.

10. The latching mechanism of claim 9, wherein the at least one sensor is an accelerometer, and the electronic control unit is configured to energize the coil to lock the latching mechanism in response to an output of the accelerometer exceeding a predetermined threshold.

11. A system of latching mechanisms for selective locking at least one first object to at least one second object, the system comprising:
at least one latching mechanism comprising:
a latch comprising a locking member having a magnetic end and a locking end, wherein the locking member pivots with respect to the latch between a locked position and an unlocked position;
an electromagnetic coil disposed in a working relationship to the magnetic end of the locking member, such that energizing the coil causes pivotal movement of the locking member;
a power source for selectively energizing the coil; and
a catch defining at least one pocket for receiving the locking end of the locking member when the locking member is in the locked position; and
a controller communicatively coupled to the at least one latching mechanism, the controller being configured to selectively lock and unlock that at least one latching mechanism.

12. The system according to claim 11, further comprising a remote device, the remote device being communicatively coupled to the controller, the remote device comprising an input to receive an instruction to selectively lock and unlock the at least one latching mechanism.

13. The system according to claim 12, wherein the remote device comprises at least one of a fob, a desktop computer, a phone, and a personal computing device.

14. The system according to claim 13, wherein the remote device is communicatively linked to the controller via a network.

15. The system according to claim 11, wherein the controller comprises a memory that includes program instructions to unlock the latching mechanism based on input identifying an authorized user.

16. The system according to claim 15, wherein the controller is configured to authorize a user based on at least one of an authorized user device, RFID tag, and biometric information.

17. A latching mechanism, comprising:
a latch that comprises a top plate, a base plate, and locking member, the locking member including a locking end, a magnetic end, and pivots disposed between the locking end and the magnetic end, the base plate comprising fulcrums on which the pivots are disposed, the locking member being configured to pivot about the pivots on the fulcrum, and the top plate being disposed above the base plate;
a cap that comprises an electromagnetic coil disposed in a working relationship to the magnetic end of the locking member, the cap being disposed above the top plate, and energizing and de-energizing of the coil causing the locking member to pivot between one of a locked and an unlocked position; and
a catch defining at least one pocket for receiving the locking end of the locking member when the locking member is in the locked position.

18. The latching mechanism of claim 17, further comprising an electronic control unit, the electronic control unit including a power source and a transceiver, the electronic control unit selectively energizing the coil to pivot the locking member into the locked and the unlocked positions.

19. The latching mechanism of claim 17, wherein the catch comprises a keeper extending from a catch base, the keeper comprises at least one projection at least partially defining the at least pocket, the projection extending from the keeper at an angle of 70 of degrees.

20. The latching mechanism of claim 18, wherein the top plate comprises ridges disposed around the locking member, the ridges preventing lateral and longitudinal movement of the locking member.
